(19) United States
(12) Patent Application Publication
(10) Pub. No.: US 2025/0382083 A1
(43) Pub. Date: Dec. 18, 2025

(54) PACKAGING ASSEMBLY FOR THE PREPARATION OF PACKAGES OF HORTICULTURAL PRODUCTS

(71) Applicant: UNITEC S.P.A., Lugo (IT)

(72) Inventor: Luca BENEDETTI, RAVENNA, Frazione Savarna (IT)

(21) Appl. No.: 18/876,039

(22) PCT Filed: Jun. 12, 2023
(86) PCT No.: PCT/EP2023/065588

§ 371 Date: Dec. 17, 2024

(30) Foreign Application Priority Data
Jun. 21, 2022 (IT) 102022000013057

(51) Int. Cl. B65B 25/04; B25J 11/00; B65B 5/10; B65B 35/18; B65B 35/58

(52) U.S. Cl. CPC B65B 25/046; B25J 11/0045; B65B 5/105; B65B 35/18; B65B 35/58

(57) ABSTRACT

A packaging assembly for the preparation of packages of horticultural products, the packaging assembling including
at least one system for handling horticultural products,
at least one instrument for viewing the horticultural products, and
at least one apparatus for the transfer of the products. The assembly furthermore includes
at least elements for the independent rotation of each product, configured to impart to each advancing product a selectively independent rotation about a first axis, and
at least one electronic control and management unit, provided with instructions for the control at least of the apparatus and of the elements on the basis at least of the information acquired by the instrument, for the variation of the spatial orientation of each product, performed by the elements and by the apparatus, until it is deposited in the respective container according to a target spatial orientation.

### CROSS-REFERENCE TO RELATED APPLICATIONS

This application is a 35 U.S.C. § 371 National Stage patent application of PCT/EP2023/065588, filed on 12 Jun. 2023, which claims the benefit of ITALIAN patent application no. 102022000013057, filed on 21 Jun. 2022, the disclosures of which are incorporated herein by reference in their entirety.

### TECHNICAL FIELD

The present disclosure relates to a packaging assembly intended for the preparation of packages of horticultural products.

### BACKGROUND

As is known, companies working in the field of packaging and distribution of fruit and horticultural products in general make extensive use of at least partially automated plants, provided with various types of handling elements, which have the task of conveying said products along a predefined path or line, along which stations and instruments of various kinds subject them to a plurality of processes and treatments.

In particular, in a first loading station the plants are fed with unsorted masses of a specific fruit (or other horticultural product), often coming directly from the harvesting fields. Along the subsequent path, the products can be checked, cleaned, washed, selected, graded, weighed, or others; in particular, the information that is acquired about each product in transit (in terms, for example, of parameters such as: color, shape, dimensions, sugar content, ripeness, any rotting, weight, etcetera) is used in various manners in order to choose the most appropriate destination for each product.

For example, sometimes special apparatuses are, in fact, arranged in sequence along the final section of the plant, which are associated with a respective collection container, and can be activated in a mutually independent manner by an electronic unit, which processes the previously acquired information so that only products that are mutually homogeneous (for one or more of the parameters mentioned above) are accumulated in each collection container.

In other cases, the products must be supplied to trays which form a plurality of laterally adjacent seats, along which said products must be placed so that each one has the same orientation. For example, in the case of apples, it may be required that they be arranged with the stem (or stalk) upward, or so as to expose upward portions of the peel with the same shade of color.

These are requirements that typically arise in order to give the resulting package a more pleasing appearance to the eyes of the consumer, but regardless of the underlying reasons they pose difficult problems to the companies in the field.

In fact, several conveyance methods are known that provide for the advancement of products one by one along at least one section of the path (indeed to perform detections on each of them), and some of them entail to impart a rotation of the products about a horizontal axis which is perpendicular to the advancement direction: however, this rotation is not sufficient to ensure that all the products arrive downstream in the same spatial orientation, as required by the above-described packaging criteria.

In practice, therefore, in order to meet the above-described packaging requirements, known solutions provide for terminal stations in which several devices cooperate with each other to dictate further rotations on the products, take them from the line and deposit them on the tray in the desired orientation.

However, these are very complex and expensive systems, which moreover often dictate a temporary stop on the products, to allow indeed a further rotation, but thus cause an undesirable increase in cycle time and in any case constitute a bottleneck for the entire plant.

### SUMMARY

The aim of the present disclosure is to solve the problems described above, providing a packaging assembly capable of arranging horticultural products in respective packages according to a specific spatial orientation, with a simple and low-cost solution.

Within this aim, the disclosure provides a packaging method that allows to arrange horticultural products in respective packages according to a specific spatial orientation in a simple and low-cost manner.

The disclosure also provides a packaging assembly that can operate with a reduced time cycle, without dictating stops on the products and without constituting a bottleneck for the whole process.

The disclosure further provides an assembly capable of preparing packages of products oriented according to specific requirements, using a handling unit with a low number of degrees of freedom.

The disclosure advantageously provides a packaging assembly that ensures high reliability in operation.

Another feature of the disclosure is to provide a packaging assembly and method that use a technical and structural architecture that is alternative to those of assemblies of the known type.

Not least feature of the disclosure is to provide a packaging assembly and method that can be obtained easily starting from commonly commercially available elements and materials.

Yet another advantage of the disclosure is to provide a packaging assembly and method that have low costs and are of assured application.

This aim and these and other advantages that will become better apparent hereinafter are achieved by an assembly and a method according to the claims and disclosure set forth herein.

### BRIEF DESCRIPTION OF THE DRAWINGS

Further characteristics and advantages of the disclosure will become better apparent from the description of a preferred but not exclusive embodiment of the packaging assembly according to the disclosure, illustrated by way of non-limiting example in the accompanying drawings, wherein:

FIG. 1 is a lateral elevation view of the packaging assembly according to the disclosure;

FIG. 2 is a top view of the assembly of FIG. 1;

FIG. 3 is a sectional view of FIG. 2, taken along the plane III-III;

FIG. 4 is a view of a highly enlarged detail of FIG. 3, showing in detail the independent rotation means;

FIG. 5 is a lateral elevation view of a further possible component of the assembly;

FIG. 6 is a view of a package that can be prepared by the assembly of FIG. 1; and

FIG. 7 is a block diagram of the method according to the disclosure.

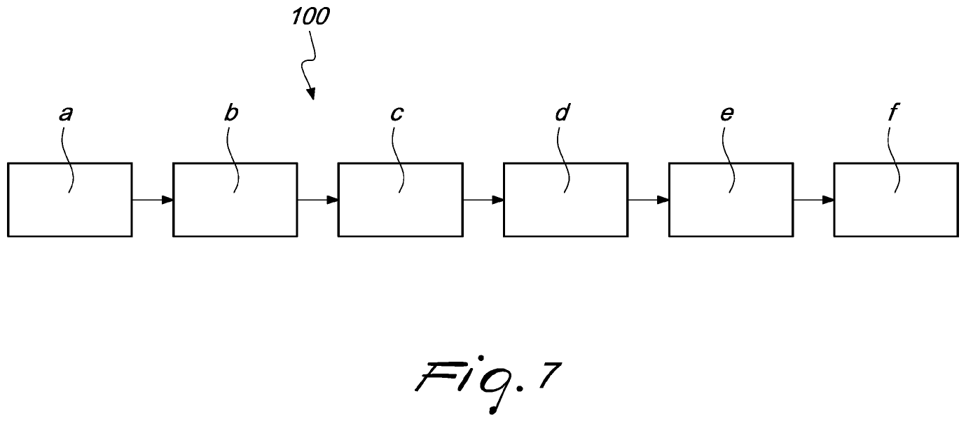

### DETAILED DESCRIPTION OF THE DRAWINGS

With particular reference to the figures, a packaging assembly, adapted for the preparation of packages A of horticultural products B, is generally designated by the reference numeral 1.

The horticultural products B may be of any type (fruit, vegetables, garden produce, etcetera): the accompanying figures show products B constituted by apples. This is a merely exemplifying choice, which corresponds to an application of considerable practical interest, which in any case does not limit the protective scope claimed herein.

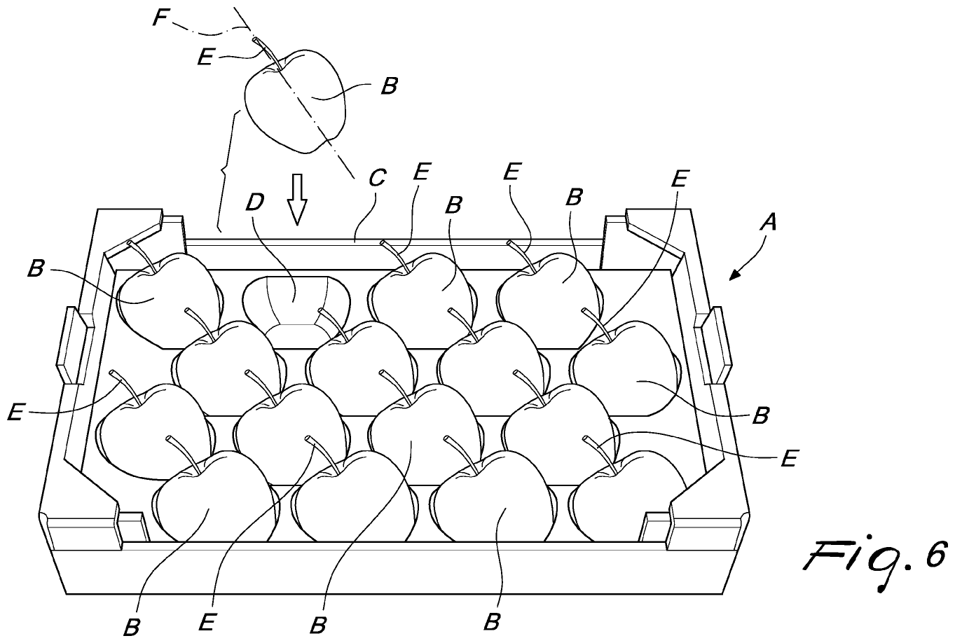

Preferably, the packages A that the assembly 1 is designed to prepare are of the type shown in FIG. 6, and therefore provide for containers C of the type of cellular trays or crates, in any case such as to define a plurality of laterally adjacent recesses D or cells, each of which is adapted to receive a respective product B. Even more particularly, the primary object of the assembly 1 according to the disclosure relates to preparing packages A in which the products B (be they apples or others) are arranged in the containers C according to a target spatial orientation, wherein the latter can be chosen in various manners as a function of the specific requirements. Typically, these requirements entail that the target spatial orientation is the same for all the products B (or in any case must comply with a common criterion), but it is also possible to provide for a target orientation that is different from product B to product B, for example as a function of the spatial arrangement of each one of them in the container C.

For example, the requirement may be that all the products B be arranged with the stem E (or stalk) oriented in the same direction, for example so that as in FIG. 6, the imaginary axes F of the products B (defined as the straight line joining the stem E and the calyx) are parallel to each other and inclined with respect to the horizontal plane so as to form a predefined angle, which is common for all the products B. These requirements may indeed occur in relation to apples or other fruits having a stem E. Moreover, the target spatial orientation may be required to consist in directing upward the most colored portion of the product B (or in any case the one closest to a particular color shade, for example because it is considered most pleasing to the eyes of the consumer) or also in directing upward the label applied to the peel.

The target spatial orientation may also consist of a combination of two or more requirements/conditions: for example, one solution of considerable practical interest indeed provides that the imaginary axes F are arranged horizontally and mutually parallel or aligned and that at the same time the product B exposes upward the most colored portion.

In any case, other criteria for defining the target spatial orientation are not excluded, and it is specified in general that the term “spatial orientation” in the present description is understood to mean in any case, in a manner that is anyhow intuitive, the arrangement assumed by an object (by the product B) in space, and thus its inclination, direction and/or, indeed, orientation, with respect to the three Cartesian axes or to any fixed reference.

It should also be specified that the target spatial orientation may correspond to one and only one position of the product B in space, or to a plurality of positions that satisfy the same criterion. For example, in fact, if just a specific inclination of the imaginary axis F is required, the target spatial orientation referenced in the present description can be understood to correspond to the infinite specific arrangements that meet the criterion of interest (which can be obtained by rotating the product B about the imaginary axis F).

In any case, it is not excluded to use the assembly 1 to arrange the products B in other types of containers C, possibly even without concern for ensuring in the latter an orderly accumulation of said products B (and therefore without taking full advantage of the particularities of the disclosure that will be described hereinafter, but only indeed to prepare packages A of any kind).

The assembly 1 comprises at least one system 2 for handling the products B, which is configured at least to make them advance one by one along a predefined path (which is typically but not necessarily rectilinear).

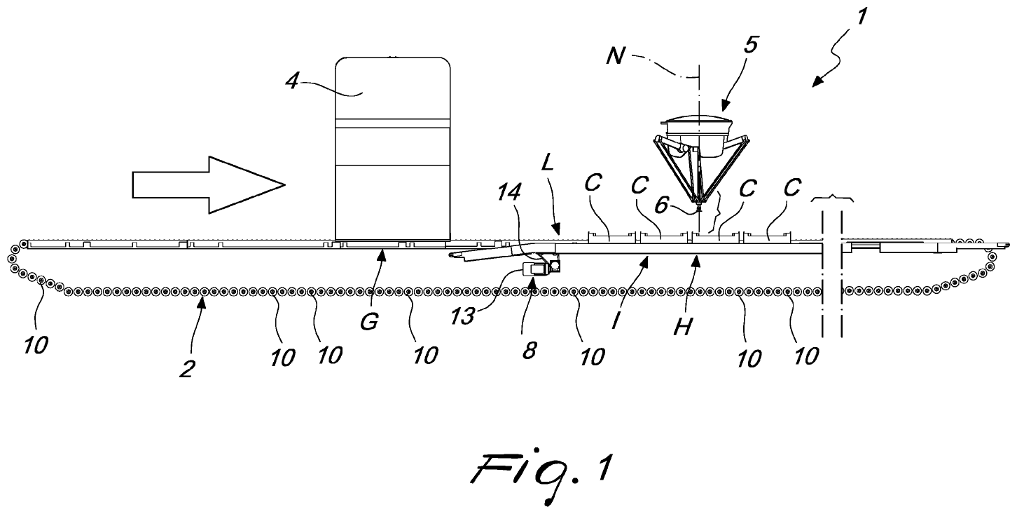

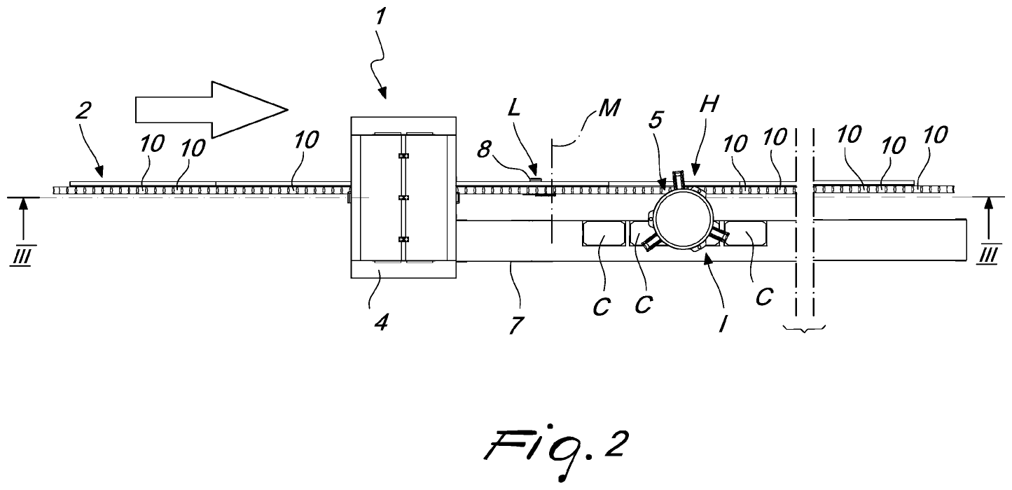

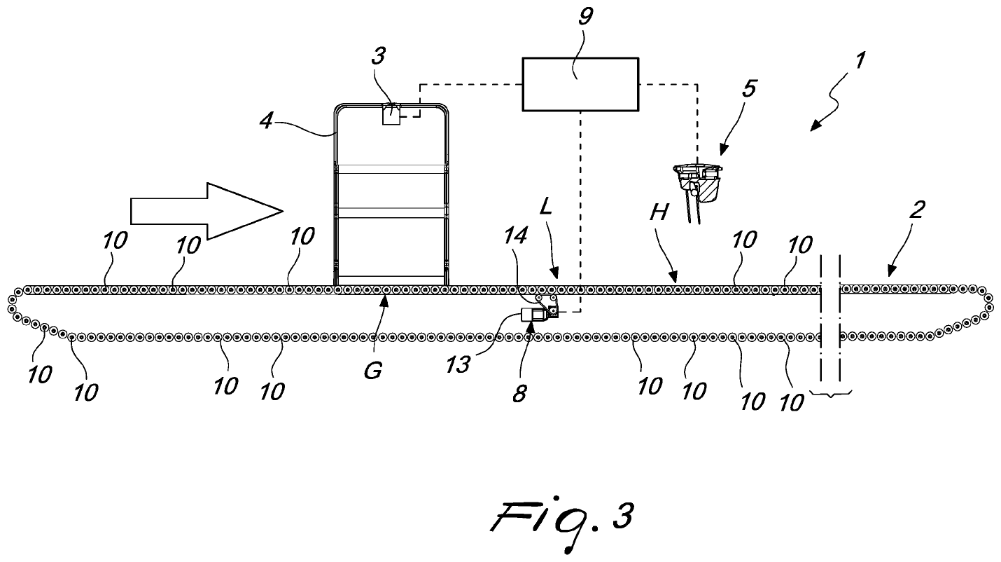

In the solution of the accompanying figures, all of the products B move along the same path, but the possibility is provided that the paths along which the products B advance may also be two or more, typically parallel: the remarks made in the preceding pages and in those that follow should be understood to extend to each path identifiable in the assembly 1. The handling system 2 identifies in any case one and only one advancement direction of the products B (indicated with an arrow in FIGS. 1 to 5) and therefore hereinafter the terms “upstream”, “downstream”, “upstream of” and “downstream of” are used here, according to common usage, indeed with respect to this advancement direction (from left to right in the accompanying figures), which allows the products B to move from a loading region (of any type) to the terminal region, which will be described hereinafter.

Furthermore, the assembly 1 comprises at least one instrument 3 for viewing the horticultural products B, which is arranged along a first portion G of the path and is configured at least to acquire information regarding a first spatial orientation (which does not necessarily correspond to the target spatial orientation and indeed is usually different) assumed by each product B advancing along said first portion G. The manners in which, in practice, the instrument 3 acquires the information introduced above can be any and even of a per se known type. In particular, the instrument 3 may comprise one or more electronic video cameras, preferably placed inside a tunnel 4 (so as to shield the first portion G from external light and unwanted environmental disturbances) and in any case directed toward the first portion G.

Furthermore, the assembly 1 comprises at least one apparatus 5 for the transfer of the products B, which comprises a grip element 6 provided with four (and only four) degrees of freedom (with respect to a fixed Cartesian reference system) and is configured to transfer the products B one by one from a terminal portion H of the path, arranged downstream of the first portion G, to a respective packaging area I, in which it is possible to arrange at least one respective container C of products B. As will be better clarified hereinafter, by virtue of the four degrees of freedom given to the grip element 6, the spatial orientation can be changed during the transfer performed by the apparatus 5.

The apparatus 5 can be chosen of a per se known type and is typically a manipulator or robot, which at its free end indeed carries the grip element 6, to which any rule of motion can be assigned and which is directly in charge of gripping one product B at a time, taking it from the terminal portion H and depositing it in the containers C. In particular, preferably the apparatus 5 deposits each product B into a respective recess D.

The apparatus 5 can pick up the products B while they are advancing along the path or the products may be stopped indeed for pickup by the apparatus 5.

The grip element 6 can be of any type and can use any known technology to ensure a firm grip of the product B (and typically the technology is chosen according to the specific product B to be conveyed, its critical aspects and in particular the greater or lower delicacy of treatment that it requires).

The accompanying figures show, merely by way of example, a grip element 6 which uses a sucker, connected to a respective pneumatic suction circuit, to firmly grip each apple without compromising its integrity in any way.

A portion of a conveyor belt 7 or in any case another automatic or semiautomatic device that has the task of making the containers C available to the apparatus 5 may be located in the packaging area I (for each product B, the apparatus 5 may have one or even multiple containers C available); likewise, other manners of feeding the containers C may be provided. For example, an operator may be active in the area I and periodically places at least one empty container C on a worktable, waiting for it to be filled by the apparatus 5, to then remove the resulting package A and restart the cycle with a new empty container C.

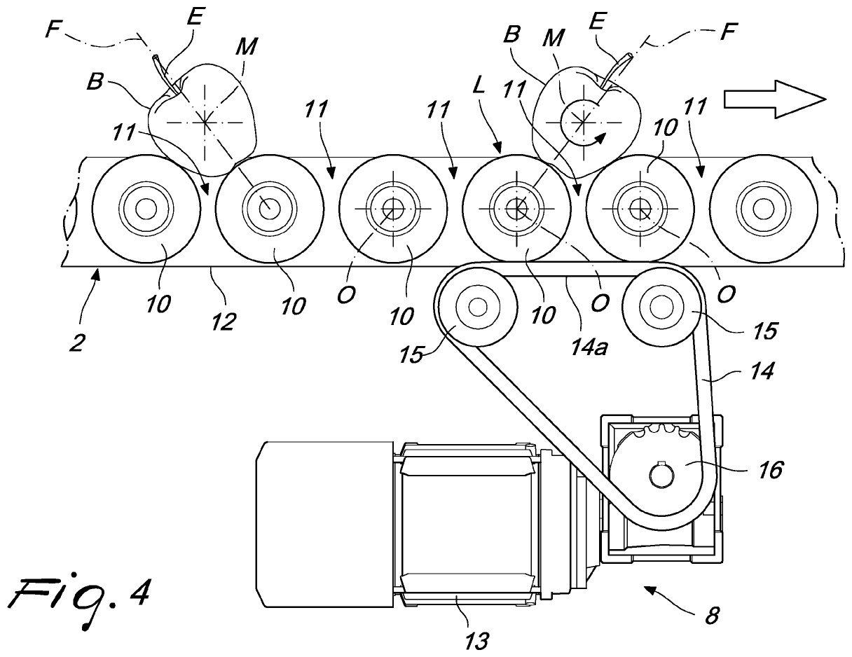

According to the disclosure, the assembly 1 comprises at least means 8 for the independent rotation of each product B, which in one possible embodiment, are the subject matter of the detail of FIG. 4. Said means 8 are arranged along a second portion L of the path, downstream of the first portion G (and typically upstream of the terminal portion H, although it might partially overlap the latter).

The means 8 are configured to impart to each product B that is advancing (along the path) a selectively independent rotation about a first axis M, which is substantially horizontal and transverse (preferably at right angles) to the advancement direction. The first axis M is in fact at right angles to the ideal plane on which FIGS. 1, 3 and 4 lie.

The term “selectively independent rotation” means that the rotation imparted to each product B can be chosen of any extent, independently of the extent of the rotation chosen for each product B upstream or downstream. Indeed to ensure a “selectively independent” rotation, it is preferable that, at least at the second portion L, each product B is suitably spaced from the one that directly precedes it and from the subsequent one.

The term “extent” of the rotation obviously means the number of degrees of the rotation.

Furthermore, according to the disclosure the assembly 1 comprises at least one electronic control and management unit 9, which is provided with instructions for controlling at least the apparatus 5 (with the grip element 6) and the means 8 on the basis at least of the information acquired by the instrument 3, for the variation of the spatial orientation of each product B, which is performed indeed by the means 8 and by the apparatus 5, until it is deposited in the respective container C according to the target spatial orientation (as defined above).

The electronic unit 9 (shown only schematically, for the sake of simplicity, in the accompanying figures) can be of any type, and for example can be a controller, a PLC or a computer; moreover, it can be dedicated solely to the execution of the task described above or can be a controller or PLC that also performs other tasks. Typically, in any case, it is the same device that oversees and governs the operation of the entire assembly 1 (and optionally of the plant in which it is inserted).

In other words, the electronic unit 9 processes the information received from the instrument 3, in order to determine the extents of the rotations and of the movements in general that the means 8 and the apparatus 5 (the grip element 6) must impose on each product B so that the spatial orientation changes from the one detected by the instrument 3 to the one that must be assumed in the packages A (in the containers C). For this purpose, the electronic unit 9 is provided with appropriate calculation software, which can in any case be chosen from software products that are already on the market or provided for this specific purpose, in manners known to the person skilled in the art (bearing in mind the particular objective described above). The electronic unit 9 can also take care of calculating the exact point of the terminal portion G where to pick up each product B and the rule of motion required to transfer each product B from the handling system 2 to the container C (to the appropriate recess D, for example).

Since the orientation assumed upstream and therefore along the first portion G is normally not the same, the motions imposed by the electronic unit 9 are different from product B to product B, in any case so as to obtain packages A in which the products B are arranged in the target spatial orientation (regardless of the upstream feeding conditions), which corresponds to any predefined criterion.

Therefore, this allows to achieve the intended aim.

In particular, the grip element 6 is provided at least with the possibility to rotate about a second axis N, which is substantially vertical (FIG. 1), and this rotation about the second axis N therefore constitutes one of the four degrees of freedom of the grip element 6. The other three degrees can correspond to the possibility to translate along the three Cartesian axes.

The translation allows to convey the products B between any two points in space (if within the range of the apparatus 5), while the rotation about the second axis N cooperates with the one imparted by the means 8, about the first axis M, to vary the spatial orientation, as desired. However, it is not excluded to provide the apparatus 5 with (at least partially) different degrees of freedom, for example, two degrees of rotation and two degrees of translation.

The ways in which the handling system 2 ensures the advancement of the products B one by one along the path may be any without thereby abandoning the protective scope claimed herein. In fact, it is possible to use cups, saucers, trays, or other devices to convey the products B, if they are compatible with the manners of operation already described and those described hereinafter.

In the preferred embodiment shown in the accompanying figures by way of non-limiting example of the application of the disclosure, the handling system 2 comprises a plurality of substantially axially symmetrical bodies 10 which are aligned and can move cyclically along the path (with an axis of symmetry O which is transverse and preferably at right angles to the path).

According to per se known methods, at least some pairs of bodies 10, which are consecutive, form respective reception and conveyance seats 11 for corresponding products B, which can in fact be rested (as can be seen clearly in FIG. 4) on said pairs substantially at the interspace between the respective two bodies 10.

The bodies 10 can be shaped like rollers which are cylindrical or have another shape, preferably an axially symmetrical one (like an hourglass o so-called diabolo, for example) as a function of the specific requirements.

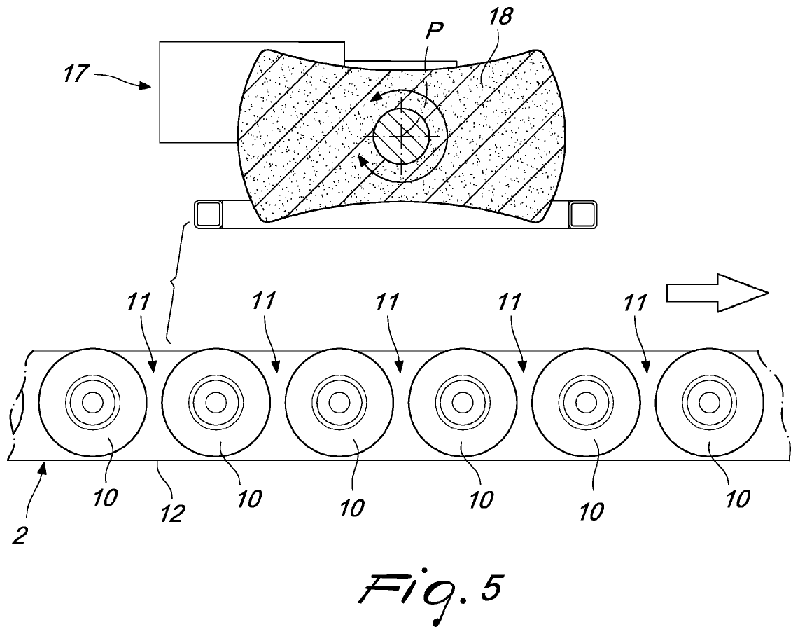

More particularly, each body 10 is supported by a traction element 12 (FIGS. 4 and 5) with the possibility of rotation about its own axis of symmetry O, which is parallel to the first axis M. The traction element 12 can comprise a chain wound in a loop, a portion of which defines the path imposed on the products B.

In particular, each body 10 is supported by the traction element 12 with the possibility of rotation in a mode chosen between free rotation and preferably an at least partially braked (or friction-controlled) rotation.

Therefore, in the first case the body 10 is supported freely by the traction element 12, while in the second case (to be preferred for the reasons that will be described hereinafter) the rotation of the body 10 occurs only when a force is imparted which is of such an extent as to overcome the resistance offered by a brake or a friction mechanism (of any kind) that opposes the rotation (in any case, typically by friction).

In the preferred embodiment, shown in the accompany figures in any case by way of non-limiting example of the disclosure, the means 8 for independent rotation comprise a drive unit 13, which is controlled by the electronic unit 9, for driving a motion transmission element 14, such as a belt (optionally provided with teeth) or the like.

Also by virtue of pulleys 15, gears 16 and similar transmission components, which define its arrangement in space and allow its movement, the transmission element 14 is wound and movable along a predefined trajectory and comprises a respective active segment 14a which faces in a parallel arrangement the second portion L of the path and is proximate thereto. By virtue of this particular arrangement, the transmission element 14 can engage with the pair of consecutive bodies 10 that transits along the second portion L and is configured to impart to the respective product B that rests on the pair (at that moment in transit along the second portion L) a selectively independent rotation about the first axis M, indeed as a consequence of the engagement of the transmission element 14 with said pair of bodies 10 and of the motion imparted selectively by the drive unit 13 to said motion transmission element 14. The length of the active segment 14a is chosen such as to engage, in any moment, a single pair of consecutive bodies 10.

In practice, therefore, as long as the motion transmission element 14 remains inert, in contact with or proximate to the bodies 10, said bodies can advance undisturbed (and/or all undergo, by friction, a same rotation, in step with any advancement imposed by the system 2 and therefore such as to cancel out any rotation imposed on the product B).

The electronic unit 9 can instead be in charge of actuating the drive unit 13 and therefore of moving the motion transmission element 14, for a time and at a speed chosen conveniently, in each instance, in order to impart to the product B that at that moment is in transit along the second portion L, a rotation (about the first axis M) of the desired extent (depending on the spatial orientation that it will have to assume in the package A and taking into account the movements that the apparatus 5 can also impart).

For an optimization of the functionality described above, the braked rotation mode of the bodies 10 (introduced above) is to be preferred: in fact, the choice to keep them normally braked avoids the danger that, downstream of the first portion L (or downstream of other points of the path where, as will become apparent hereinafter, there is the possibility to impose a rotation on the bodies 10 and the products B), due for example to a thrust of excessive extent imparted by the transmission element 14 (or other component to which the rotation is entrusted), said bodies 10 may rotate further in an uncontrolled manner, by inertia, and therefore vary in an undesirable (and random) manner the orientation of the product B involved.

The transmission of motion to the bodies 10 can occur by simple friction or by meshing (if the transmission element 14 is a chain and the bodies 10 have a partial external set of teeth), and in either case it is possible, as anticipated, to impart a rotation in step with any advancement imposed by the system 2, when one does not wish to alter the orientation of the products B.

In this regard, the active segment 14a of the transmission element 14 can be provided with a motion to approach and move away from the bodies 10, so as to not interfere in any way with the advancement of said bodies as long as selective rotation is not required, and so that it can be moved closer to the bodies 10, in order to engage with them, only when necessary.

Usefully, the assembly 1 can comprise a repositioning apparatus 17 (FIG. 5), which is arranged along the path, upstream of the means 8. For example, the apparatus 17 can be arranged between the first portion G and the second portion L or, preferably, upstream of the first portion G (and of the instrument 3). The apparatus 17 is configured for the movement of a product B arranged in a predefined station (typically but not necessarily a seat 11) toward one of the adjacent predefined stations.

For this purpose, the apparatus 17 may comprise an actuator 18 which rotates about a central axis P, which is parallel to the first axis M, and is arranged above the path and the bodies 10: normally, the actuator 18 does not interfere with the advancement of the bodies 10 but may be rotated, for example by the electronic unit 9, when the occupation of two consecutive seats 11 by two respective products B is detected. In this case, the rotation causes the actuator 18 to direct an enlarged portion toward the product B at a greater radial distance (from its own central axis P), which affects one of the two products B and pushes it downstream or upstream, where a free seat 11 is located.

The apparatus 17 ensures better conditions of operation of the means 8, at least in the embodiment of the accompanying figures. In fact, in said embodiment it is preferable that the pair of bodies 10 rotated at a given moment by said means 8 supports one and only one product B (the one arranged in the interspace between them) and that therefore neither of the two bodies 10 cooperates with a third body 10—arranged upstream or downstream—for the support of another product B. More in general, it is preferable that when a seat 11 is occupied (by a product B), the adjacent seats 11 are free (in order to prevent the extent of rotation that one wishes to impart to a product B affects the nearby ones). The apparatus 17 ensures compliance with this condition (of “alternating” filling), which can in any case also be achieved according to other modes (or even by controlling the upstream feeding of the handling system 2).

It is specified, in any case, that the presence of the apparatus 17 (or of other solutions that ensure the same function) is only optional in the assembly 1, since for example in the absence of the apparatus 17 one might merely ensure a very low filling percentage of the seats 11 (much lower than 50%), in any case acceptable if a higher hourly productivity is not required. As an alternative, it would be possible to resort to the intervention of an operator, who would be in charge of “supervising” the filling of the seats 11 and of manually remedying an unwanted placement of the products B.

In a first embodiment of the disclosure, the only rotation to which the products B are subjected while they advance along the path by virtue of the action of the handling system 2 is the one due to the means 8.

In the preferred embodiment, instead, the assembly 1 comprises at least one preliminary rotation device, which is arranged (at least) along the first portion G and is configured to impart to the advancing products B a preliminary rotation about the first axis M.

This preliminary rotation can simultaneously involve any desired number of products B and be such as to impose (on all the products B) a complete rotation (through 360°) about the first axis M, in order to expose progressively upward (to the viewing field of the viewing instrument 3) the entire external surface of said products B.

In particular, therefore, the device can comprise a motion transmission element, such as a belt, a chain, or the like, which is wound and movable along a trajectory which has a respective useful fraction which faces in a parallel manner, and is proximate to, the first portion G of the path. Said transmission element can thus engage with a plurality of bodies 10 which are consecutive, while they transit progressively along the first portion G, in order to impart to all the respective advancing products B a preliminary rotation about the first axis M.

This is in any case a technique already known in the field, which will not be dwelt upon further (and indeed for this reason is not shown in detail in the figures).

Regardless of the embodiment adopted for the device introduced above, the rotation imparted by it allows first of all an optimal acquisition of the information related to the first spatial orientation, assumed by each advancing product B. It should be noted, moreover, that while said information is being acquired, the product B rotates about the first axis M, therefore changing its spatial orientation at each moment: this is not a problem, for several reasons. First of all, in fact, the change relates to only one degree of freedom (the rotation about the first axis M) and therefore, for example, the stem E or a specific point of interest can remain stationary (if located along the first axis M), and also because in any case it is sufficient to complete the rotation at approximately the exit from the viewing field of the instrument 3 in order to know precisely the first spatial orientation of interest, assumed upon entering the range of action of the means 8. In any case, therefore, the information provided by the instrument 3 to the electronic unit 9 is sufficient to allow said unit to determine the extent of the rotations to be imparted successively to each product B in order to obtain the target spatial orientation.

However, it is not excluded to impose additional rotations of the same extent about the first axis M on the advancing products B (typically upstream of the first portion G and the instrument 3), for example, to bring them closer to the target spatial orientation.

With reference to the already mentioned possibility that in the target spatial orientation the imaginary axis F is horizontal, said rotations may also prove useful in preparing an apple to reach this condition, since the specific shape of this fruit is such that, as a result of the rotation about the axis M, it naturally tends to rest and be arranged at least approximately in this manner. In other words, said rotation allows to prepare the product B to assume the target spatial orientation, in which the task of giving said orientation to said product B is then left to the means 8 and to the apparatus 5.

Usefully, the instrument 3 is (also) configured for the acquisition of data related to at least one parameter of interest of each advancing horticultural product B, wherein said at least one parameter is chosen preferably among color, shape, dimensions, sugar content, degree of ripeness, defectiveness, and weight.

In other words, the graphic processing software with which the instrument 3 is provided is capable of acquiring not only information on the first spatial orientation but also data on other parameters of interest, which are in any case useful for the management of each product B.

More particularly, the electronic unit 9 can be provided with instructions (also) for depositing each product B in a destination chosen from a list of (possible) sorting options that comprises at least one container C and at least one other collection element (be it another container C, an evacuation belt or a trapdoor designed for rejects, or others), as a function of the data acquired regarding said parameter of interest. For this purpose, the apparatus 5 can obviously have simultaneously at its disposal multiple containers C (and/or other collection elements). This allows not only to provide packages A in which the products B all have the target spatial orientation, but also to uniformly accumulate in each container C the products B, as a function of the parameters read indeed by the instrument 3. Likewise, in this manner it is possible to assign to the unit 9 the task of accumulating in a trapdoor (or of sorting to an evacuation belt) those products B for which defects or other conditions have been detected that recommend not sending them to the end user.

Indeed if the acquisition of data on the parameters is provided, the presence of the preliminary rotation device, which makes (preferably completely) the products B rotate while they transit under the viewing field of the instrument 3, is particularly appreciated.

A packaging method 100 intended for preparing packages A of horticultural products B, which can move along a predefined path along which they are made to advance one by one (for example by means of the handling system 2), constitutes a subject matter of the present description, like the assembly 1 described so far.

The method 100 can be performed by means of the assembly 1 described so far, in particular by means of an assembly 1 which comprises at least the handling system 2, the instrument 3, the apparatus 5, the means 8, and the electronic unit 9.

The method 100 is intended for preparing packages A of the type already described in the previous pages and comprises the steps described hereinafter.

First of all, the method 100 provides, in a step a., for acquiring information regarding a first spatial orientation assumed by each product B advancing along a first portion G of the path. The step a. can be performed by the instrument 3.

The method 100 then provides, in a step b., for comparing the first spatial orientation with a target spatial orientation to be given to the products B in the respective packages A to be prepared.

The step b. can be performed by the electronic unit 9, which for this purpose can be configured to receive the information acquired during step a., for example by the instrument 3.

The method 100 is further adapted, in a step c., to impart to each product B advancing along a second portion L of the path, downstream of the first portion G, a selectively independent rotation about a first axis M which is substantially horizontal and transverse to the advancement direction, of an extent chosen as a function of the comparison performed during the step b. The extent must be chosen so as to at least move the product B closer to the target spatial orientation, taking into account in any case also what can be done in the subsequent steps.

The step c. can be performed by the means 8, controlled by the electronic unit 9.

Subsequently, the method 100 is adapted, in a step d., to pick up the products B one by one from a terminal portion H of the path, for example by means of at least one apparatus 5 and its grip element 6.

The method 100 is further adapted, in a step e., to impart to each product B picked up in step d. a rotation about a second substantially vertical axis N, of an extent chosen as a function of the comparison performed in step b., until the target spatial orientation is given to each product B.

The step e. can be performed by utilizing the degree of freedom of rotation given to the apparatus 5 (to the grip element 6), which is controlled in turn by the electronic unit 9.

Finally, in a step f., the method 100 is adapted to deposit each product B in a respective container C.

Therefore, by repeating the method 100 for an adequate number of products B, it is possible to obtain the progressive filling of the container C and therefore the desired package A.

In practice, the operation of the assembly 1 and of the method 100 according to the disclosure have already been described above.

To summarize, the assembly 1 is fed with products B (oriented in any manner, even randomly and variably from product B to product B), which are taken by the handling system 2, which, for example, conveys them while they are placed in the seats 11 between the bodies 10 and in any case takes care of moving them downstream along a predefined path.

Along the path, the products B are controlled by the instrument 3, which acquires information about a first spatial orientation assumed by each product B, as well as any other data of interest. The information and data are transmitted to the electronic unit 9. In this step, the products B can undergo a preliminary rotation about the first axis M, which is substantially horizontal. Typically, this rotation is of the same extent for all the products B (and equal to 360°).

Before or after the instrument 3, it is possible to place an apparatus 17 which redistributes the products B along the seats 11 if they are not adequately spaced.

Subsequently, the products B travel along the second portion L of the path, along which the means 8 act, said means being able to impart to each product B a rotation (of an extent chosen independently (with respect to the one imposed on the other products B), about the first axis M, which is horizontal.

Subsequently, the products B (partially “reoriented” by the means 8), arrive at the terminal portion H of the path, where the apparatus 5 picks them one at a time and conveys them toward the packaging area I, where a container C awaits them. During conveyance, the apparatus 5 changes the spatial orientation of each product B, in particular by virtue of the rotation about the second axis N, which is substantially vertical.

Thus, by choosing the most appropriate extents of rotation in each instance, the products B are placed in the container C in the target spatial orientation (which may be the same for all the products B, as in FIG. 6, or different, as a function of the specific requirements), regardless of the one assumed in the initial section of the path.

In practice it has been found that the assembly and the method according to the disclosure fully achieve the intended aim, since they allow to arrange products B in respective packages A according to a specific (target) spatial orientation, with a simple and low-cost solution. This is made possible by the presence of the means 8 and by the action of the electronic unit 9, which controls in a “synergistic” manner said means 8 and the apparatus 9, so that as a whole the rotations and the other movements imparted by said components are such as to bring each product B to the target spatial orientation, starting from any first detected orientation.

In particular, the movements imposed on each product B in order to give it the target spatial orientation and deposit it in the containers C are imparted by the means 8 and by an apparatus 5 with only four degrees of freedom, therefore in a simple and low-cost manner. In particular, in fact, the means 8 can provide for a simple drive unit 13 and a motion transmission element 14, of the type of a belt (optionally with teeth) or the like, which interacts with bodies 10 which are provided per se in known manners (and are in turn low-cost). The only four degrees of freedom of the manipulator (or apparatus 5) are also an assurance of constructive simplicity (and low cost).

The assignment of the desired orientation occurs while the products B are being made to advance along the path, in the second portion L, and while they are being conveyed by the apparatus 5, however without having to impose stops, without having to slow down the normally provided work cycles and certainly without causing an unwelcome bottleneck for the entire process, also thanks to the reduced number of degrees of freedom given to the apparatus 5, which can thus be constituted by a simple and fast robot or manipulator.

The disclosure thus conceived is susceptible of numerous modifications and variations, all of which are within the scope of the appended claims; all the details may furthermore be replaced with other technically equivalent elements.

In the exemplary embodiments shown, individual characteristics, given in relation to specific examples, may actually be replaced with other different characteristics that exist in other exemplary embodiments.

In practice, the materials used, as well as the dimensions, may be any according to the requirements and the state of the art.

1.-12. (canceled)

13. A packaging assembly for the preparation of packages of horticultural products, comprising:
at least one system for handling horticultural products, configured at least for an advancement of the horticultural products one by one along a predefined path,
at least one instrument for viewing the horticultural products, which is arranged along a first portion of said path and is configured at least for an acquisition of information regarding a first spatial orientation, assumed by each horticultural product advancing along said first portion,
at least one apparatus for a transfer of the horticultural products, which comprises a grip element provided with four degrees of freedom and configured for the transfer of the horticultural products one by one from a terminal portion of said path, arranged downstream of said first portion, to a respective packaging area, in which it is possible to arrange at least one respective container of horticultural products,
comprising:
at least means for independent rotation of each horticultural product, which are arranged along a second portion of said path, downstream of said first portion, said means being configured to impart to each advancing horticultural product a selectively independent rotation about a first axis, which is substantially horizontal and transverse to an advancement direction,
at least one electronic control and management unit, provided with instructions for control at least of said apparatus and of said means for independent rotation of each product on the basis at least of the information acquired by said instrument, for a variation of a spatial orientation of each horticultural product, performed by said means and by said apparatus, until the horticultural product is deposited in the respective container according to a target spatial orientation.

14. The assembly according to claim 13, wherein said grip element is provided at least with the possibility to rotate about a second axis, which is substantially vertical, the rotation about said second axis constituting one of said four degrees of freedom of said grip element

15. The assembly according to claim 13, wherein said handling system comprises a plurality of substantially axially symmetrical bodies which are aligned and can move cyclically along said path, at least some pairs of said bodies, which are consecutive, defining respective reception and conveyance seats for corresponding products, which can be rested on said pairs substantially at an interspace between the respective said two bodies.

16. The assembly according to claim 15, wherein each one of said bodies is supported by a traction element with a possibility of rotation about an axis of symmetry thereof, which is parallel to said first axis.

17. The assembly according to claim 16, wherein each one of said bodies is supported by said traction element with a possibility of rotation according to a mode chosen between free rotation and an at least partially braked rotation.

18. The assembly according to claim 13, wherein said means for independent rotation comprises a drive unit, which is controlled by said electronic unit, of a motion transmission element, such as a belt or the like, said motion transmission element being wound and movable along a predefined trajectory and comprising a respective active segment which faces in a parallel arrangement said second portion of said path and is proximate thereto, said motion transmission element being engageable with the pair of said consecutive bodies that transits along said second portion, and being configured to impart to the respective horticultural product which rests on said pair a selectively independent rotation about said first axis, as a consequence of an engagement of said motion transmission element with said pair of said consecutive bodies and of a motion imparted selectively by said drive unit to said motion transmission element.

19. The assembly according to claim 13, further comprising a repositioning apparatus, which is arranged along said path, upstream of said means for independent rotation of each product, and is configured for a movement of a horticultural product arranged in a predefined station toward one of the adjacent predefined stations.

20. The assembly according to claim 13, further comprising at least one preliminary rotation device, which is arranged along said first portion and is configured to impart to the advancing products a preliminary rotation about said first axis.

21. The assembly according to claim 20, wherein said at least one device comprises a motion transmission element, such as a belt, a chain, or the like, which is wound and movable along a trajectory which has a respective useful fraction which faces in a parallel manner, and is proximate to, said first portion of said path, said transmission element being engageable with a plurality of said bodies which are consecutive and transit progressively along said first portion in order to impart to all the respective advancing horticultural products a preliminary rotation about said first axis.

22. The assembly according to claim 13, wherein said instrument is configured for the acquisition of data related to at least one parameter of interest of each advancing horticultural product, said at least one parameter being chosen from color, shape, dimensions, sugar content, degree of ripeness, defectiveness, and weight.

23. The assembly according to claim 13, wherein said electronic unit is provided with instructions for depositing each horticultural product in a destination chosen from a list of sorting options, said list comprising at least one container and at least one other collection element, as a function of the data acquired regarding said at least one parameter of interest.

24. A packaging method for preparing packages of horticultural products which can move along a predefined path along which the horticultural products they are made to advance one by one, comprising the following steps:
a. acquiring information regarding a first spatial orientation assumed by each horticultural product advancing along a first portion of the path,
b. comparing a first spatial orientation with a target spatial orientation to be given to the horticultural products in respective packages to be prepared,
c. imparting to each horticultural product advancing along a second portion of the path, downstream of the first portion, a selectively independent rotation about a first axis which is substantially horizontal and transverse to the advancement direction, with an extent chosen as a function of the comparison performed in said step b,
d. picking up one by one the horticultural products from a terminal portion of the path,
e. imparting to each horticultural product picked up a rotation about a second substantially vertical axis, with an extent chosen as a function of the comparison performed in said step b., until the target spatial orientation is given to each horticultural product,
f. depositing each horticultural product in a respective container.
